(19) United States
(12) Patent Application Publication
(10) Pub. No.: US 2026/0161908 A1
(43) Pub. Date: Jun. 11, 2026

(54) SYSTEMS AND METHODS FOR SCANNING A UNIQUE CODE AND ACCESSING PERSONALIZED CONTENT ASSOCIATED WITH THE UNIQUE CODE RELATED APPLICATIONS

(71) Applicant: Naomi Disten-Zuckerman, Potomac, MD (US)

(72) Inventor: Naomi Disten-Zuckerman, Potomac, MD (US)

(21) Appl. No.: 19/409,288

(22) Filed: Dec. 4, 2025

Related U.S. Application Data
(60) Provisional application No. 63/728,537, filed on Dec. 5, 2024.

(51) Int. Cl. G06K 7/14

(52) U.S. Cl. CPC G06K 7/1417

(57) ABSTRACT

In one aspect, a system may include a unique code associated with an inanimate object, a person, another living organism, or combinations thereof. The system may also include a first and/or a second computing system, where the first and/or the second computing system may be configured to create and/or post personalized and/or personalizable content associated with the unique code. The first and/or the second computing system may include a camera configured to scan the unique code. The first and/or the second computing system may also include a display configured to display the personalized and/or personalizable content associated with the unique code.

### RELATED APPLICATIONS

This application this claims priority to U.S. Provisional Patent Application No. 63/728,537 titled Systems And/Or Methods That Utilize A Unique Code For Creating And/Or Posting Personalized And/Or Personalizable Content Associated With The Unique Code, filed on Dec. 5, 2024, which is incorporated herein by reference in its entirety.

### BACKGROUND

One-dimensional (1-D) codes, two-dimensional (2-D) codes, and three-dimensional (3-D)

codes can be used for data encoding, data transmission, and data storage. Coding systems incorporating such codes can enhance data efficiency, security, and/or accessibility across various industries. A Quick Response (QR) code is a type of two-dimensional (matrix) barcode that stores information in a pattern of black and white squares (pixels) and can be read by a digital device, such as a smartphone camera. The QR code acts as a bridge between the physical and digital worlds, providing instant access to data or triggering an action in a mobile device, such as a smartphone, when scanned.

### BRIEF DESCRIPTION OF THE DRAWINGS

FIG. 1 shows a diagram of a unique code and a computing system, in accordance with

examples described herein.

FIG. 2 shows a diagram of a first person having clothing printed with one or more unique codes, and a second person using a smartphone to scan the one or more unique codes associated with the first person, in accordance with examples described herein.

FIG. 3A, FIG. 3B, and FIG. 3C are flowcharts of a method(s) arranged in accordance with examples described herein.

FIG. 4 illustrates a block diagram of a system in accordance with examples described

herein.

FIG. 5 illustrates a block diagram of a venue in which a system and method of the disclosed examples herein may operate.

### DETAILED DESCRIPTION

This disclosure describes a system and method utilizing one or more unique codes

embedded in or on an inanimate object, a living organism, or combinations thereof to post, communicate, and/or advertise personalized and/or personalizable content, such as messages, images, videos, etc. In some embodiments, “a unique code” or “the unique code” may be referred herein as “a code,” “the code,” or “said code.” A code includes 1-D codes, 2-D codes, and 3-D codes.

In some embodiments, the inanimate object may be or include one or more items of clothing, clothing accessory(ies), bag(s), briefcase(s), tool(s), office supply(ies), personal item(s), vehicle(s), furniture(s), home dwelling(s), office(s), building(s), piece(s) of art (e.g., a painting, a sculpture), billboard(s), combinations thereof, and/or any other inanimate objects. The code may be stitched, printed, clamped, adhered, pinned, weaved, or embedded in or on the inanimate object using other mechanical, electrical, magnetic, and/or electronic means.

In some embodiments, the living organism may be a person, another person, a pet, a livestock, a wild animal, a zoo animal, or another living organism in the kingdom Animalia. The code may be adhered to, clamped on, or attached with a piercing, tagged (e.g., ear tagged), temporarily or permanently tattooed, branded, or embedded in or on the living organism using other mechanical, thermal, electrical, magnetic, and/or electronic means.

It is to be understood that a person has full control of whether they want to be associated with the unique code. That is, another person, an organization, a business, a government, or any other entity cannot or should not coerce and/or force the person to be associated with the code, without the person's explicit permission, consent, will, and/or desire. The person associated with the unique code has free will to be associated with said code. The systems and/or methods described herein meet and/or exceed individual rights that are granted and/or protected by local, state, national, and/or international jurisdictions.

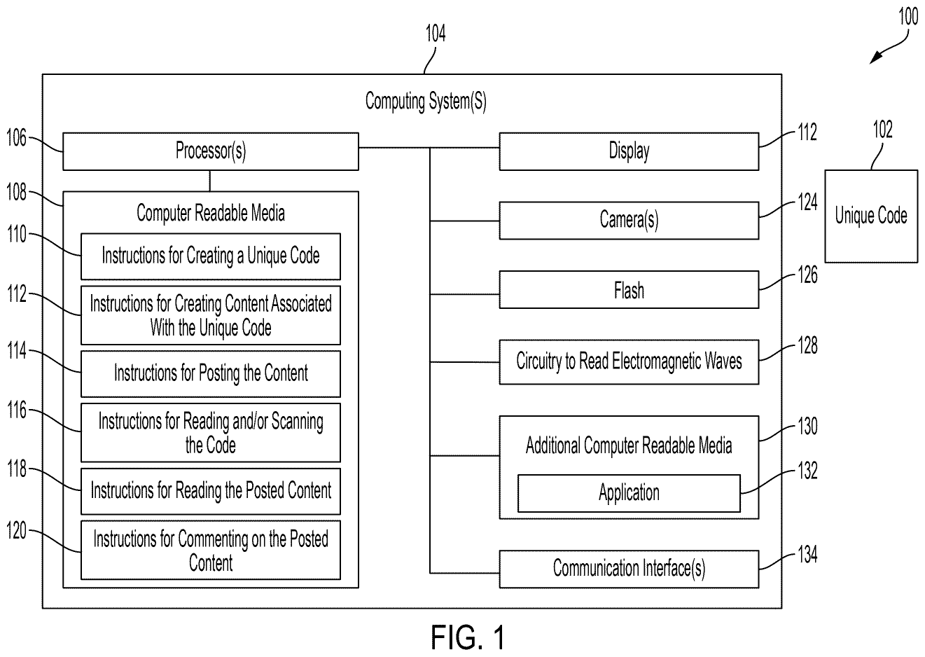

FIG. 1 shows a diagram 100 of a unique code 102 and a computing system(s) 104, in accordance with examples described herein. The unique code 102 may be associated with an inanimate object, a person, or combinations thereof. The computing system(s) 104 may include a smartphone, a tablet, a laptop, a desktop computer, a smartwatch, computing or smart eyeglasses, a VR/AR headset, a gaming system or controller, a smart speaker system, a television, an entertainment system, an automobile or a function thereof, a trackpad, a drawing pad, a netbook, an e-reader, a security system, an appliance, and/or other computing systems.

In some embodiments, the unique code 102 may be a quick response (QR) code, which may be a matrix barcode that allows data encoding of up to, for example, 4296 ASCII characters. Generally, the QR code is widely used across numerous industries for quick access to information via, for example, smartphones, scanners, etc.

In some embodiments, the unique code 102 may be a data matrix, which may be 2-D barcode or QR code, generally having, for example, black and white cells arranged in a square or rectangular pattern. The data matrix may be utilized for high data density, allowing storage of large amounts of information in a small area.

In some embodiments, the unique code 102 may be an Aztec code. Generally, the Aztec code has a distinctive bullseye pattern at the center. The Aztec code can encode data efficiently, which can be read at various angles.

In some embodiments, the unique code 102 may be a PDF417 code, which includes a stacked linear barcode format. Generally, the PDF417 code is capable of encoding a substantial amount of data.

In some embodiments, the unique code 102 may be a MaxiCode, which is a matrix barcode that can hold up to, for example, 93 characters.

In some embodiments, the unique code 102 may be a code 128, which is a high-density linear barcode symbology that can encode 128 ASCII characters.

In some embodiments, the unique code 102 may be a code 39, which is a linear barcode that supports alphanumeric characters.

In some embodiments, the unique code 102 may be a Microsoft Tag, which utilizes high-capacity color barcodes (HCCBs) that encode data in a pattern of colored triangles, providing a more information-dense encoding compared to, for example, traditional QR codes.

In some embodiments, the unique code 102 may utilize a near field communication (NFC) tag.

In some embodiments, the unique code 102 may utilize radio frequency identification (RFID) tags, by utilizing electromagnetic fields to automatically identify and/or track tags attached to the inanimate object, the living organism, or combinations thereof.

In some embodiments, the unique code 102 may be a chroma code, which uses color patterns to encode data, allowing more information to be stored compared to black and white codes.

In some embodiments, the unique code 102 may another code that is not explicitly described herein. In some embodiments, the unique code 102 may be a combination of the two or more codes.

Regardless of the type of code used in the system and/or methods described herein, the particular code may be designed for specific applications, environments, use cases, situations, industries, etc., and the type of the unique code 102 can be chosen based on the required data capacity, space constraints, use case, cost, visual appeal, and/or other factors.

In some embodiments, the computing system(s) 104 may include or utilize a processor(s) 106; a computer readable media 108 encoded with instructions for creating a unique code 110, instructions for creating content associated with the unique code 112, instructions for posting the content 114, instructions for reading and/or scanning the code 116, instructions for reading the posted content 118, and/or instructions for commenting on the posted content 120; a display 122; a camera(s) 124; a flash 126; a circuitry to read electromagnetic waves 128; an additional computer readable media 130 storing, or utilized by, an application 132; and a communication interface(s) 134. In some embodiments, the computing system(s) 104 may include fewer, additional, and/or different components than what is shown in FIG. 1.

In some embodiments, the processor(s) 106 may be capable of processing, receiving, and/or transmitting instructions that may be included in, permanently or temporarily saved on, and/or accessed by the computer readable media 108, the additional computer readable media 130, and/or another computer readable media that is not illustrated in FIG. 1. In aspects, the processor(s) 106 may be implemented using one or more processors (e.g., a central processing unit (CPU), a graphic processing unit (GPU)), and/or other circuitry, where the other circuitry may include at least one or more of an application specific integrated circuit (ASIC), a field programmable gate array (FPGA), a microprocessor, a microcomputer, and/or the like. Furthermore, the processor(s) 106 may be configured to execute the instructions for creating a unique code 110, the instructions for creating content associated with the unique code 112, the instructions for posting the content 114, the instructions for reading and/or scanning the code 116, the instructions for reading the posted content 118, the instructions for commenting on the posted content 120, and/or instructions associated with the application 132. The processor(s) 106 can be used to process instructions that make the computer readable media 108, the display 122, the camera(s) 124, the circuitry to read electromagnetic waves 128, the additional computer readable media 130, the communication interface(s) 134, or other components of the computing system(s) 104 function properly or as intended.

In some embodiments, the instructions for creating a unique code 110, the instructions for creating content associated with the unique code 112, the instructions for posting the content 114, the instructions for reading and/or scanning the code 116, the instructions for reading the posted content 118, the instructions for commenting on the posted content 120, and/or instructions of the application 132 may be included in, permanently or temporarily saved on, and/or accessed by the computer readable media 108 and/or the additional computer readable media 130 of the computing system(s) 104. These instructions may include code, pseudo-code, algorithms, a machine learning model, heuristics, other models, software, and/or so forth and may be executable by the computing system(s) 104.

In some embodiments, the computer readable media 108 and/or the additional computer readable media 130 may be and/or include any data storage media, such as volatile memory and/or non-volatile memory. Examples of volatile memory may include a random-access memory (RAM), such as a static RAM (SRAM), a dynamic RAM (DRAM), or a combination thereof. Examples of non-volatile memory may include a read-only memory (ROM), a flash memory (e.g., NAND flash memory, NOR flash memory), a magnetic storage medium, an optical medium, a ferroelectric RAM (FeRAM), a resistive RAM (RRAM), and so forth.

In some embodiments, the display 122 may utilize a variety of display technologies, such as a liquid-crystal display (LCD) technology, a light-emitting diode (LED), backlit LCD technology, a thin-film transistor (TFT) LCD technology, an LED display technology, an organic LED (OLED) display technology, an active-matrix OLED (AMOLED) display technology, a super AMOLED display technology, and so forth. The user of the computing system(s) 104 can utilize the display 122 to create a unique code associated with an inanimate object or a person (e.g., the user themselves), create content (e.g., by using a keyboard displayed on the display 122, by using camera(s) 124 to capture a photo or record a video, by using computational resources and/or artificial intelligence (AI), etc.), post the content (e.g., on a social media platform), posting on a content, messaging another person, etc.

In some embodiments, the camera(s) 124 may include one or more image sensors. A user of the computing system(s) 104 can scan the unique code 102 by utilizing the camera(s) 124. Generally, image sensors can convert optical images into electronic signals. For example, the camera(s) 124 may include or utilize charge-coupled device (CCD) sensors, which utilize capacitors to move electrical charge across a chip to an analog-to-digital (ADC) converter. CCD sensors capture high-quality images with low noise levels. As another example, the camera(s) 124 may include or utilize complementary metal-oxide-semiconductor (CMOS) sensors. As another example, the camera(s) 124 may include or utilize backside-illuminated (BSI) CMOS sensors, which are a variation of CMOS sensors, where the photo-sensitive surface is placed on the rear, allowing more light to reach the sensor. As another example, the camera(s) 124 may include or utilize live MOS sensors, which may be a hybrid between CCD and CMOS technologies, and which can be used in digital single-lens reflex (DSLR) and mirrorless cameras. As another example, the camera(s) 124 may include or utilize Foveon X3 sensors. As another example, the camera(s) 124 may include or utilize infrared (IR) or near-IR sensors. As yet another example, the camera(s) 124 may include or utilize a combination of sensors described herein.

In some embodiments, the circuitry to read electromagnetic waves 128 may include an antenna to capture incoming electromagnetic signals (e.g., signals from an NFC tag, an RFID tag), and the circuitry to read electromagnetic waves 128 can convert these incoming signals to other electromagnetic signals and/or digital signals. The circuitry to read electromagnetic waves 128 may include amplifiers, filters, a mixer, an analog-to-digital converter (ADC), modulators, demodulators, and/or other electronic circuits. In some embodiments, the digital signals can be processed by the processor(s) 106 to decode information embedded in the electromagnetic waves. The information may include content created and/or posted by a user, where the information may be associated with an inanimate object, the person themselves, another living organism, or combinations thereof.

FIG. 1 shows that the application 132 is stored in the additional computer readable media 130. Alternatively, the application 132 may be stored in computer readable media 108 or other computer readable media. Alternatively, the application 132 or portions of application 132 may be stored on a server (e.g., a cloud server), and the user may utilize the computing system(s) 104 to access and/or utilize the application 132.

In some embodiments, the application 132 may be a software application, such as a social network software application, an enterprise resource planning (ERP) system, a warehouse management system (WMS), inventory management software, point of sale (POS) software, demand forecasting software, collaboration tools software, an online community platform, a content management system (CMS), enterprise social networking software, a customer engagement platform, or combinations thereof. The application 132 may be installed on the computing system(s) 104 or accessed using the computing system(s) 104; a function of the computing system(s) 104; a peripheral of the computing system(s) 104; or another entity.

In some embodiments, the application 132 may use or access the instructions for creating a unique code 110, the instructions for creating content associated with the unique code 112, the instructions for posting the content 114, the instructions for reading and/or scanning the code 116, the instructions for reading the posted content 118, the instructions for commenting on the posted content 120, and/or other instructions.

In some embodiments, the user may utilize the application 132 to create the unique code 102. The user can then generate, or cause to be generated, a physical manifestation of the unique code 102 (e.g., print). Alternatively, the user can communicate the unique code 102 to a business that can replicate and/or manufacture the physical manifestation of an image of the unique code. The user or the business can then associate the unique code 102 to an inanimate object, for example, by stitching, printing, clamping, adhering, pinning, weaving, or embedding in or on the inanimate object using other mechanical, electrical, magnetic, and/or electronic means.

Additionally, or alternatively, the user can associate the unique code 102 with the user themselves or another living organism. For example, the user can elect to create a temporary tattoo on their forearm (or another body part), where the tattoo is an image of the unique code 102. The user (e.g., a first user) can utilize the application 132 to create and/or post content on a platform (e.g., social media platform) supported by, or integrated with, the application 132. In some embodiments, the creator and/or managing entity of the application 132 can create a specific social media platform for users to create, post, and/or consume (e.g., read, watch) content. Additionally, or alternatively, the application 132 can be integrated with a plurality of social media platforms, such a specific social media platform and/or a third-party social media platform.

In some embodiments, another user (e.g., a second user) using another computing system(s) 104 (e.g., their own computing system(s) 104) can log in on their own account of the application 132. The other user (e.g., the second user), with the explicit or implicit permission of the first user, can scan the unique code 102 associated with the first user by using, for example, the camera(s) 124 or the circuitry to read electromagnetic waves 128 of their own computing system(s) 104 (e.g., a computing system(s) 104 of the second user). The other user can then read the content created and/or posted by the first user. In some embodiments, the other user can comment on the content created and/or posted by the first user. The first user can configure the application 132 to selectively allow or deny other user(s) to read the content created by the first user; to selectively allow or deny the other user(s) commenting on the content created by the first user; to selectively allow or deny the other user(s) contacting the first user; or combinations thereof.

In some embodiments, an explicit permission may include the second user asking the first user to scan the unique code 102 associated with the first user. In some embodiments, an implicit permission may include the first user displaying the unique code 102 to the second user. In some embodiments, an explicit and/or implicit permission can be a membership or an account of the application 132, where the membership may query each user to sign or accept a license grant; restrictions; acknowledgment of the intellectual property associated with the unique code 102, the computing system(s) 104, and/or the application 132; a warranty disclaimer; a limitation of liability; terms and conditions; governing law; and/or so forth.

In some embodiments, the application 132 may support or include a graphical user interface (GUI) that aids the user to interact with the computing system(s) 104, the application 132, the unique code 102, and/or the person associated with the unique code 102 through, for example, graphical icons, visual indicators, windows, buttons, menus, etc. The GUI(s) of the application 132 may be designed to be intuitive and/or user-friendly. The GUI(s) can provide visual representations of function, of content created and/or posted by the person associated with the unique code 102, or other visual representations.

For example, the person associated with the unique code 102 (e.g., the person who created or initiated the creation of the unique code 102) may be in a good mood, and the visual representation of this state of mind or emotion may be, for example, a “grinning face with smiling eyes” (e.g., an emoji, a meme, a short video, etc.). As another example, the application 132 may support or include a keyboard that the user can utilize to type content, and the user can associate the content with the unique code 102. Therefore, the user can utilize the application 132 to create and/or post content in real time or near real time, where the content is associated with the unique code 102.

In some embodiments, the user can update or remove the content at any time, and this updated content is associated with the same unique code 102. A second person can use their computing system(s) 104 (e.g., their smartphone) to read the unique code 102, and the second person can read (or consume) the content associated with the unique code 102. In some embodiments, the second person can comment on the content that was created and/or posted by the first person that manages the content associated with the unique code 102. In some embodiments, the comments of the second person (e.g., the person scanning the unique code 102) can only be viewed by the first person (e.g., the person creating and/or posting the content associated with the unique code 102). In some embodiments, the comments of the second person can be viewed by only a restricted list of users that was created by the first person (e.g., the person who manages the content associated with the unique code 102). For example, the restricted list of users may be anyone who is already listed as a contact in the computing system(s) 104 (e.g., contacts listed on a smartphone). In some embodiments, the comments of the second person can be viewed by any user who has an account with, and/or uses, the application 132 on their own device (e.g., their own computing system(s) 104).

In some embodiments, the user who manages the content associated with the unique code 102 has full control of who can view the content associated with the unique code 102 and how they can view it. In some embodiments, the user managing the content associated with the unique code 102 may configure the application 132 and/or the computing system(s) 104 to permanently delete content, for example, after a time period has passed (e.g., every day, every week, every month, or another time period); after posting new content; depending on the location of the user; depending on the time of day; and/or other time and/or social settings. For example, the user may post content “X” during work hours; content “Y” in the evenings; content “Z” at the gym; content “T” at church; content “S” at a club or dance parlor; and/or any other content depending on the environment, time of day, and/or social setting.

Generally, people may have a personal “brand” or a personal identity that may depend on the social setting. For example, a lawyer may play in a rock ‘n’ roll band on the weekends. As another example, a mechanic may be part of a book club during weeknights. As yet another example, a nurse may be the local bowling champion, and the nurse may spend considerable time with people that do not work in the medical field. Therefore, it may behoove the user to create and/or publish content associated with unique code 102, depending on their environment and/or social setting.

In some embodiments, a first computing system (e.g., computing system(s) 104) may communicate with a second computing system (e.g., another computing system(s) 104) directly or indirectly (e.g., via a network) using the communication interface(s) 134. The network may be a cellular network, the Internet, a wide area network (WAN), a local area network (LAN), a wireless LAN (WLAN), a wireless personal-area network (WPAN), a mesh network, a wireless wide area network (WWAN), a peer-to-peer (P2P) network, and/or a Global Navigation Satellite System (GNSS) (e.g., Global Positioning System (GPS), Galileo, Quasi-Zenith Satellite System (QZSS), BeiDou, GLObal NAvigation Satellite System (GLONASS), Indian Regional Navigation Satellite System (IRNSS), and so forth).

In addition to, or alternatively, the communications illustrated in FIG. 1, computing system(s) 104, the unique code 102, or another entity (e.g., a server) may facilitate other unidirectional, bidirectional, wired, wireless, direct, and/or indirect communications utilizing one or more communication protocols and/or standards.

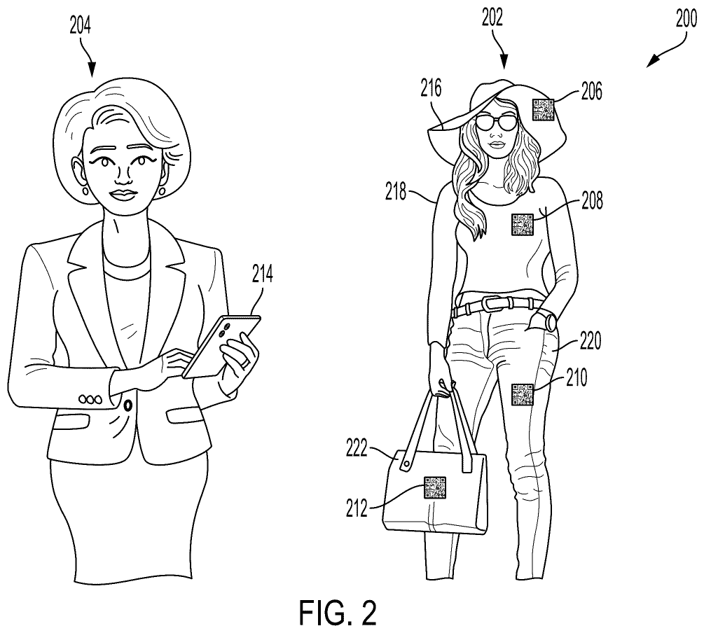

FIG. 2 shows a diagram 200 of first person 202 having clothing printed with one or more unique codes, and a second person 204 using a smartphone 214 to scan the one or more unique codes associated with the first person 202, in accordance with examples described herein. FIG. 2 is illustrated and/or described in the context of FIG. 1.

The smartphone 214 is an example computing system(s) 104. Additionally, or alternatively, the person 204 may use other computing systems or devices, such as a VR/AR headset, a tablet, a laptop, a smartwatch, computing or smart eyeglasses, a netbook, an e-reader, and/or other computing devices.

As is shown in FIG. 2, the person 202 is wearing a hat 216 with a unique code 206; a top 218 (e.g., blouse, shirt, T-shirt, etc.) with a unique code 208; and jeans 220 (e.g., pants, trousers) with a unique code 210; and holding a bag 222 (e.g., handbag, briefcase, etc.) with a unique code 212. The unique codes 206, 208, 210, and 212 may be the same unique code (e.g., unique code 102 of FIG. 1) or may be different unique codes.

In some embodiments, the person 202 may have created (or may have had ordered) a unique code (e.g., unique code 102 of FIG. 1), and the person 202 may have printed, attached, adhered, embedded in or on, etc. the same unique code on her hat 216, her top 218, her jeans 220, and her bag 222. In such a scenario, the unique code 102 of FIG. 1 may be the same as the unique codes 206, 208, 210, and 212 of FIG. 2. Although not explicitly illustrated in FIG. 2, the person 202 may use the computing system(s) 104 and/or the application 132 of FIG. 1 to create the unique code, and the person 202 may create content associated with the unique code. The person 202 may then post the content on, for example, a social media platform associated with the application 132.

In some embodiments, the person 204 may utilize their smartphone 214 to scan the unique code 206, the unique code 208, the unique code 210, and/or the unique code 212. By so doing, the person 202 can read the content created and posted by the person 202. For example, the person 202 and the person 204 may be in a crowded bar. In such an environment and/or social setting, the content may read “I am Jane. I am 22 years old. I play volleyball. I am single.” As another example, the person 202 and the person 204 may be attending a career fare. In such an environment and/or social setting, the content may read “[m]y name is Jane Doe. I am 22 years old. I am studying to be an electrical engineer. I am seeking an internship at a reputable engineering company. Please read my CV or resume.” Therefore, the person 202 can create and post content based on the environment and/or the social setting. The person 202 can change (e.g., remove, add, update, etc.) the content at any time, with relative ease, by using the application 132 of FIG. 1, in real time or near real time. Consequently, the person 204, after scanning the code, can read (or consume) the content created and posted by the person 202.

As another example, the person 202 may have created unique codes for each clothing item. In such a scenario, the unique codes 206, 208, 210, and 212 may be different from each other. The person 202 can selectively create and/or post the same, or different, content associated with each of the unique codes 206, 208, 210, and 212. For example, the person 202 may create and post content associated with the unique code 206 of the hat 216, stating “I love summer!” As another example, the person 202 may create and post content associated with the unique code 212 of the bag 222, stating “[p]lease follow me on my career social media platform.” As another example, the person 202 may create and post content associated with the unique code 210 of the jeans 220, stating “[y]ou are uncomfortably close to my personal space.” As yet another example, the person 202 may create and post a cheeky comment associated with the unique code 208 of the top 218, stating “[y]ou have been staring at me for too long.” Therefore, depending on which unique code the person 204 scans with their computing device (e.g., the smartphone 214), the person 204 will read (or consume) a different comment created and posted by the person 202.

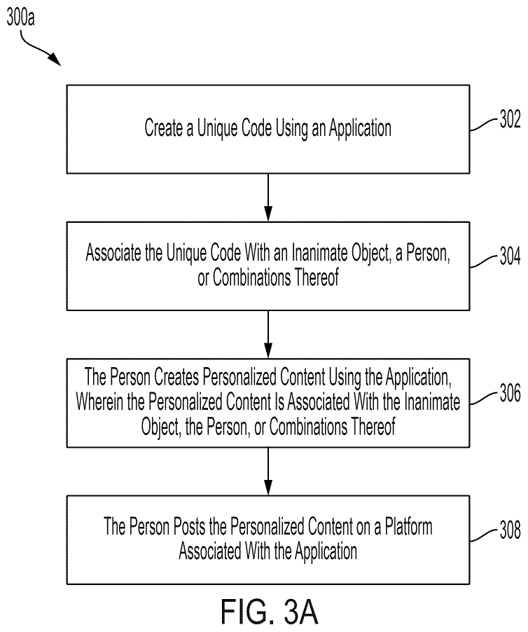

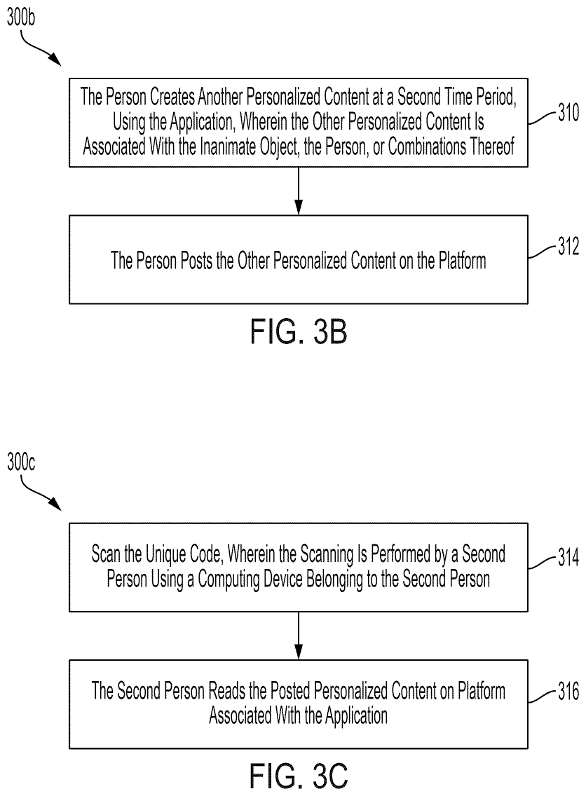

FIGS. 3A, 3B, and 3C are flowcharts of a method 300a, a method 300b, and a method 300c, respectively, in accordance with examples described herein. FIGS. 3A, 3B, and 3C are illustrated and described in the context of FIGS. 1 and 2. The methods may be performed, for example, by the person 202 of FIG. 2, the person 204 of FIG. 2, or combinations thereof. For example, parts of these methods may be performed by a first user or person (e.g., the person 202), and parts of these methods may be performed by a second user or person (e.g., the person 204). Additionally, or alternatively, each person may perform the methods. The blocks of the methods may have other arrangements than what is shown in FIGS. 3A, 3B, and 3C.

In some embodiments, in block 302 of FIG. 3A, a method 300a may include a person (e.g., the person 202 of FIG. 2) creating a unique code (e.g., unique code 102 of FIG. 1) using an application (e.g., the application 132 of FIG. 1). For example, the person may create an account using and/or associated with the application 132 of FIG. 1. After creating the account, the person may use, for example, the GUI of the application 132 to create the unique code.

In block 304 of FIG. 3A, the method 300a may include the person associating the unique code with an inanimate object, the person themself, or combinations thereof. Additionally, or alternatively, the person may associate the unique code with another living organism, such as a pet, a farm animal, a zoo animal, a wild animal, etc. Depending on whether the association includes the inanimate object, the person, or another living organism, the person may perform the association by, for example, stitching, printing, clamping, adhering, pinning, piercing, tagging, temporarily or permanently tattooing, weaving, branding, and/or embedding in or on the unique code using other thermal, mechanical, electrical, magnetic, and/or electronic means.

In block 306 of FIG. 3A, the method 300a may include the person creating personalized (or personalizable) content, using the application 132 of FIG. 1, where the personalized content is associated with the inanimate object, the person, or combinations thereof. At a time of the person's choosing, the person (e.g., person 202 of FIG. 2) may utilize the application 132 to type a message; use emojis; create a meme; record a video; download a video on their computing system(s) 104 and/or a server (e.g., clod server) associated with the application 132; draw an image; and/or create another type of content.

In block 308 of FIG. 3A, the method 300a may include the person (e.g., the person 202 of FIG. 2) posting the personalized content on a platform (e.g., a first-party and/or a third-party social media platform), where the platform is associated with the application 132 of FIG. 1.

In some embodiments, in block 310 of FIG. 3B, a method 300b may include the person (e.g., the person 202 of FIG. 2) creating another personalized content at a second time period using the application 132 of FIG. 1. In some embodiments, this other personalized content is also associated with the inanimate object, the person, or combinations thereof. Additionally, or alternatively, the person may associate the unique code and/or the other personalized content with the other living organism, such as the pet, the farm animal, the zoo animal, the wild animal, etc.

In some embodiments, in block 312 of FIG. 3B, the method 300b may include the person (e.g., the person 202 of FIG. 3B) posting the other personalized content, for example, on the social media platform associated with the application 132 of FIG. 1. In some embodiments, the method 300b may include the person (e.g., person 202 of FIG. 2) replacing the personalized or personalizable content created at the first time (e.g., block 306 of FIG. 3A) with the other personalized or personalizable content created at the second time (e.g., block 312 of FIG. 3B). In some embodiments, the method 300b may also include the application 132 of FIG. 1 to permanently delete the personalized content created at the first time (e.g., created at the block 306 of FIG. 3A). Alternatively, the person 202 of FIG. 2 may selectively configure the application 132 of FIG. 1 to keep a record of one or more previous posts.

In some embodiments, in block 314 of FIG. 3C, a method 300c may include a second person (e.g., person 204 of FIG. 2) scanning the unique code using their own computing device (e.g., their own computing system(s) 104 of FIG. 1, the smartphone 214 of FIG. 2, etc.). For the sake of clarity, the unique code being scanned by the second person (e.g., person 204) may be associated with and/or managed by the first person (e.g., person 202 of FIG. 2); the inanimate object belonging to and/or associated with the first person; the first person themself; or combinations thereof.

Additionally, or alternatively, the unique code may be associated with another living organism, such as a pet, a farm animal, a zoo animal, a wild animal, etc. The unique code may be managed by the first person. For example, the first person may be a rancher, and the rancher may associate the farm animal with the unique code. Continuing with this example, the second person may be a veterinary doctor (vet). The vet may use their own computing device to scan the unique code and read the content posted by the rancher.

In some embodiments, in block 316 of FIG. 3C, the method 300c may include the second person reading (or consuming) the posted personalized content on a platform associated with the application 132, after the second person scans the unique code. For the sake of clarity, in some embodiments, the personalized content may have been created and/or posted by the first person.

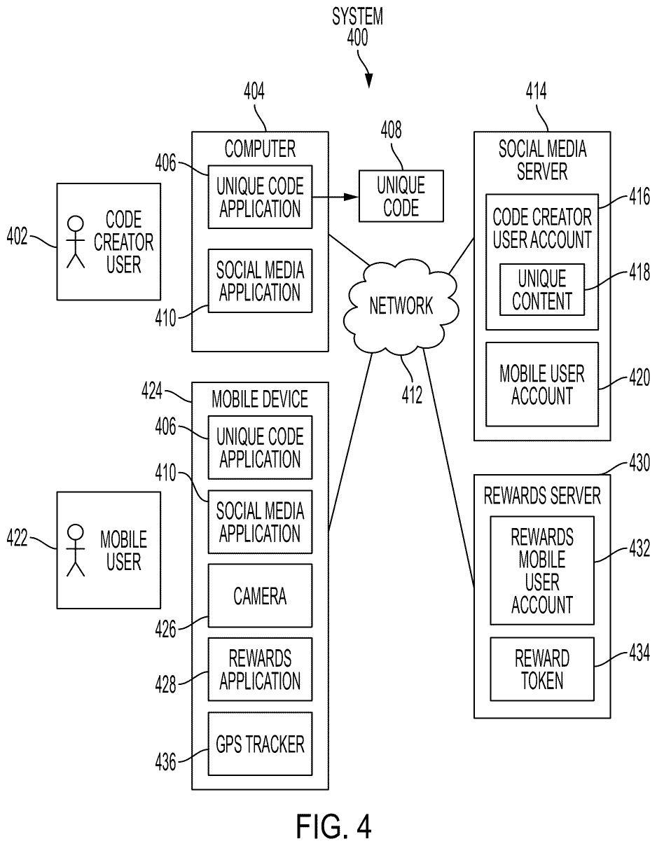

Referring to FIG. 4, a system 400 for generating and reading a unique code is shown. The system 400 allows the generation of a unique code which may then be placed, in tangible form, in one or more locations on animate or inanimate objects. Mobile device scanning of the unique codes to yield incentives encourages users to physically travel to locations where the unique codes are present. The incentives to scan codes may include personalized and unique social media content such as text, graphics, video, invitation to electronically converse, invitation to follow on a social media platform, invitation to subscribe on the social media platform, the option to post unique content on a social media platform, and the like. The incentives may also include rewards in the form of promotions, discounts, loyalty program points, and the like. By encouraging the physical presence of a user, foot traffic to a venue may be increased.

A code creator user 402 may operate a computer 404, as disclosed herein, to run a unique code application 406. As the name suggests, the unique code application 406 generates a unique code 408, as disclosed herein. The unique code 408 may be fixed in tangible form, such as being physically printed, and placed in or more locations on objects, people, and the like as disclosed herein. The computer 404 may also include a social media application 410 to allow interaction with a social media platform.

The computer 404 is in electrical communication with a network 412 which may be embodied in various forms as disclosed herein. The network 412 is in communication with a social media server 414.

The social media server 414 provides operation for any one of the various social media platforms commonly in use. The social media server 414 may include a code creator user account 416 corresponding to the code creator user 402 which enables the code creator user 402 to maintain an account on a social media platform. The code creator user account 416 may include corresponding unique content 418 which corresponds to the unique code 408. When the unique code 408 is scanned, the unique content 418 may be accessed. The unique content 418 is an incentive for users to participate and physically travel to where the unique code is present. The unique content 418 may be a message in the form of text, graphics, video, invitations to participate on the social media platform, and the like. The unique content 418 may include information about the code creator user, information on products and services, information about promotions and related activities, information on participations in loyalty rewards programs or club memberships, and any other various marketing materials. In one embodiment, the unique content 418 may only be accessed by scanning the unique code 408. Alternatively, the unique content 418 may be selectively provided to followers and subscribers to the code creator user account 416. Alternatively, the unique content 418 may be available to any user on the social media platform and who views the code creator user account 416.

The social media server 414 includes a plurality of additional user accounts including a mobile user account 420. The mobile user account 420 enables a mobile user 422 to participate on a social media platform provided by the social media server 414.

The mobile user 422 operates a mobile device 424, as disclosed herein such as a smartphone, tablet, and the like. The mobile device 424 includes a camera 426 to allow scanning of the unique code 408. The mobile device 424 may also include the social media application 410 to allow the mobile user 422 to access the social media server 414 and the mobile user account 420 and participate on the social media platform.

When the mobile user 422 uses the mobile device 424 to scan a unique code 408, the social media server 414 may provide the unique content 418 to the social media application 410 on the mobile device 424. In an alternative embodiment, the unique content 418 may be available to the mobile device 424 and the mobile user 422 without the use of the social media application 410 being resident on the mobile device 424.

In one embodiment, the unique content 418 is not available to users on the social media platform except for the code creator user 402. In this way, the unique content 418 may only be accessed by scanning the unique code 408 with a mobile device 424.

In one embodiment, the mobile device 424 includes the unique code application 406. When the mobile device 424 scans the unique code 408, the unique content 408 is provided to the unique code application 406.

In operation, a code creator user 402 may post on the code creator user account 416 that the code creator user 402 will be at a certain physical location. The code creator user 402 may generate the unique code 408 and place the unique code 408 on or in proximity to the code creator user's person. A mobile user 422, seeing the post, may be encouraged to visit the physical location where the unique code 408 is present. The mobile user 422 may use the mobile device 424 and scan the unique code 408 and receive access to the unique content 418. The unique content 418 may include text, graphics, video and the like which may inform the mobile user 422 about additional information and/or incentives corresponding to the code creator user 402.

In one example, the mobile user 422 may see the unique code 408 at a physical location and scan the unique code 408 and access the unique content 418. The unique content 418 may include information specific to the code creator user 402, information about the apparel and accessories worn by the code creator user 402, information about the physical location where the code creator user 402 is present, or any combination thereof. The unique content 418 may also include an invitation to participate in a game, challenge, promotion or the like being supported by the code creator user 402. Thus, a mobile user 422 curious about a prominent display of a unique code 408 may scan the unique code 408 and have access to unique content 418 hosted on a social media server 414.

In another example, the unique content 418 may be accessed by the mobile user 422 and the mobile user 422 may be allowed to post the unique content 418 on the mobile user account 420. In one example, a code creator user may go by the name of Jack and the unique content 418 may include a banner stating “enjoying the weekend on the Boardwalk with Jack!” The unique content 418 may also include a link to subscribe and/or follow the code creator user. The mobile user 422 may be allowed to post the banner and the associated link on the mobile user account 420 to thereby increase the public awareness of both the code creator user 402 and the physical location. Thus, an incentive may be for a mobile user 422 to post unique content 418 on a mobile user account 420.

The mobile device 424 may also include a rewards application 428 to allow the mobile user 422 to participate in a promotion, receive a coupon or discount, receive points in a loyalty program, and the like. The incentive to participate may be referred to herein as a reward incentive. The mobile device 424 is in electronic communication with the network 412 which is in electronic communication with a rewards server 430. The rewards server 430 may include a rewards mobile user account 432 which corresponds to the mobile user 422 and may include information relating to promotions, discounts, coupons, loyalty points, and the like.

The code creator user 402 may be an entity, such as a retail store, airlines, theme park, restaurant, and the like, which would like to encourage customers and potential customers to visit a physical location. The code creator user 402 generates a unique code 408 to provide an incentive for the mobile user 422 to travel to the physical location and scan the unique code 408. When the mobile device 424 captures the unique code 408, the rewards server 430 updates the rewards mobile user account 432 to reflect an incentive, such as a coupon, promotion, discount, or loyalty points. The rewards application 428, resident on the mobile device 424, is updated to indicate the incentive. The incentive may be embodied as additional points in the loyalty program, a graphic to indicate a coupon, promotion, or discount, or an indication that the coupon, promotion, or discount is available in some other form.

In one embodiment, the incentive may be generated as a reward token 434 and stored in the rewards mobile user account 432. The reward token 434 may be specific to the rewards mobile user account. Thus, it would not be transferrable to another rewards mobile user account and another mobile user would not be able to use the reward token 434 for any purpose. The reward token 434 may also be specific to a physical location. Thus, the reward token 434 may only be available for use at a certain venue, store, park, and the like. Further, the reward token 434 may have a limited time use. In one embodiment, the reward token 434 may be indicative of a game piece for use in a promotion game provided by the code creator user 402. Collection of game pieces may require a mobile user 422 to scan multiple unique codes 408 at different physical locations and possibly at different times. The unique code 408 may also generate random reward tokens 434 indicative of different game pieces thereby introducing the element of luck in game play. The specific limitations of the reward token 434 may be displayed to the mobile user 422 through the operation of the rewards application 428. The rewards application 428 may display all reward tokens 434 and corresponding promotions, coupons, discounts, loyalty points, game pieces, and the like.

In an alternative embodiment, a code creator user 402 may not rely on a rewards server 430. Instead, the code creator user 402 may rely on the unique content 418 provided by the social media server 414 to enable a discount, promotion, coupon, loyalty points, game pieces, and the like for the mobile user 422. As such, the unique content 418 may be an image, text, or graphic indicating a discount, promotion, coupon, or game piece.

The mobile device 424 may include a conventional GPS tracker 436 to confirm the location of the mobile device 424. In one embodiment, scanning the unique code 408 requires confirmation that the mobile device 424 is in the physical location of the unique code 408. Alternatively, accessing the unique content 418 or generating a rewards token 434 may require that the GPS tracker 436 confirm that the mobile device 424 was at a physical location. The intent is to prevent scanning of unique codes 408 without users traveling to the physical location.

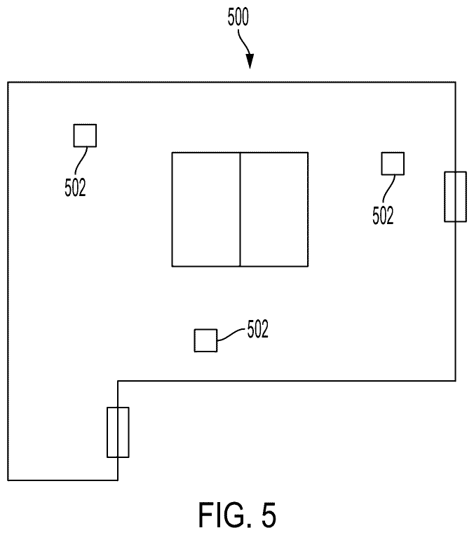

Referring to FIG. 5, a physical venue 500 is shown as a retail store. One of skill in the art will appreciate that the physical venue 500 may be embodied as a theme park, shopping mall, public park, cruise ship, museum, school, university, and the like. Unique codes 502 may be placed at the venue 500 in predetermined locations and for predetermined times to attract user participation. The unique codes 502 may be placed on signs, placards, and the like to attract attention to certain products, displays, exhibitions, and the like. The unique codes 502 may also be worn, displayed, or carried by participants as they roam through the venue 500.

Mobile users may travel through the venue 500 and scan the unique codes 502 with mobile devices to gain access to unique content 418 or generate reward tokens 434. The unique code application 406 may require scanning of multiple unique codes 408 to gain access to the unique content 418 or generation of the reward token 434. The unique code application 406 may require that the unique codes 408 be scanned in a certain order and/or during a certain time. The unique code application 406 may further require confirmation, through use of the GPS tracker 436, that the mobile device 424 is physically present at the venue 500 in order to access the unique content 418 or generation of the reward token 434.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention in this regard; no attempt is made to show algorithm details of the invention in more detail than is necessary for the fundamental understanding of the invention, the description taken with the drawings and/or examples making apparent to those skilled in the art how the several forms of the invention may be embodied in practice.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize them.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

1. A method to access unique content on a social media platform, comprising:
creating a unique code scannable by a mobile device, wherein the unique code corresponds to a first social media platform account and unique content associated with the first social media account;
providing the unique code in physical form;
a mobile device scanning the unique code in physical form;
in response to the mobile device scanning the unique code, the mobile device gaining access to the unique content on the social media platform; and
displaying the unique content on the mobile device.

2. The method of claim 1, wherein the unique code includes a quick access code.

3. The method of claim 1, wherein the unique content includes one of text, HTML link, image, and video, or combinations thereof.

4. The method of claim 1, further comprising posting the unique content on the first social media platform account.

5. The method of claim 1, further comprising posting the unique content on a second social media platform account after the mobile device gains access to the unique content.

6. The method of claim 1, wherein the unique content includes personal information associated with the user of the first social media platform account.

7. The method of claim 1, wherein the unique content is not available to users on the social media platform without scanning the unique code in physical form with a mobile device.

8. The method of claim 1, further comprising the mobile device confirming the proximity of the mobile device to the unique code in physical form before the mobile device gains access to the unique content on the social media platform.

9. A method to access a reward incentive, comprising:
creating a unique code scannable by a mobile device, wherein the unique code corresponds to the reward incentive;
providing the unique code in physical form;
a mobile device scanning the unique code in physical form;
in response to the mobile device scanning the unique code, the mobile device gaining access to the reward incentive; and
displaying the reward incentive on the mobile device.

10. The method of claim 9, wherein the unique code includes a quick access code.

11. The method of claim 9, wherein the reward incentive includes a reward token.

12. The method of claim 9, wherein the reward incentive is stored on a rewards server accessible by the mobile device.

13. The method of claim 9, wherein the reward incentive is stored on a social media server and corresponds to a social media account.

14. The method of claim 13, wherein the reward incentive is not available to users on the social media platform without scanning the unique code in physical form with a mobile device.

15. The method of claim 9, further comprising the mobile device confirming the proximity of the mobile device to the unique code in physical form before the mobile device gains access to the reward incentive.

16. A system to access unique content on a social media platform, comprising:
a computer including a unique code application to create a unique code scannable by a mobile device, wherein the unique code corresponds to a first social media platform account and unique content associated with the first social media account, and wherein the unique code is scannable in physical form by mobile devices;
a social media server configured to host the first social media platform account and the unique content;
a mobile device configured to:
scan the unique code in physical form;
gain access to the unique content on the social media server; and
display the unique content on the mobile device.

17. The system of claim 16, wherein the social media server is configured to prevent user access to the unique content without using a mobile device to scan the unique code in physical form.

18. The system of claim 16, wherein the social media server is further configured to:
host a second social media platform account; and
post the unique content on the second social media platform after the mobile device gains access to the unique content.

19. The system of claim 16, wherein the unique content includes personal information associated with a user of the first social media platform account.

20. The system of claim 16, wherein the mobile device is further configured to confirm the proximity of the mobile device to the unique code in physical form before the mobile device gains access to the unique content on the social media server.
